(19) United States
(12) Patent Application Publication
(10) Pub. No.: US 2004/0061722 A1
(43) Pub. Date: Apr. 1, 2004

(54) Passdown database and flow chart

(76) Inventors: Keith Christopher, Orlando, FL (US); Leonard Jay Olmer, Orlando, FL (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/259,255

(22) Filed: Sep. 27, 2002

(51) Int. Cl. G09G 5/00

(52) U.S. Cl. 345/771; 345/780

(57) ABSTRACT

A method of monitoring a multi-step process, the method comprising implementing a process comprising a plurality of steps represented by a process flow diagram, creating a table for recording data associated with each of the respective plurality of steps, recording data in the table responsive to activities associated with respective ones of the plurality of steps as the process implementation progresses, providing a display of at least a portion of the process flow diagram and at least a portion of the table, and providing an indication on the display of a process step of the flow diagram associated with a data entry selected from the table.

### BACKGROUND OF THE INVENTION

This invention relates to diagnosing equipment problems, and more particularly to a system and method for diagnosing equipment where a diagnosis is easily and accurately tracked and information identifying a status of the diagnosis is readily available.

Many fabrication or manufacturing facilities that produce products around the clock, or with several shifts of workers sometimes have equipment that fails or needs to be diagnosed to determine whether the equipment is working at an acceptable level after either a given time period or after producing a given number of products. For example, the assignee of this invention produces semiconductor devices. Manufacturing equipment must be cleaned to prevent small particles from accumulating on the equipment that may impinge upon semiconductor products. However, because of the length of time a diagnostic process may take, with a production line operating twenty-four hours a day, a diagnostic process may begin during one shift and not finish until a later shift where an individual who began the process is not available to complete the process. Thus, for example, when a second shift comes in following a first shift, the second shift personnel may not know what occurred during the first shift. To insure that the second shift is aware of events that occurred during the first shift, the first shift must leave some notes to indicate whether or not there are any unresolved equipment problems.

These notes should not only identify the equipment, but also should indicate what kind of test or corrective action had already been taken, or where or at what stage a previous shift had ended a process for testing or correcting a piece of equipment. Once obvious solution is to leave a piece of equipment unattended until the shift personnel who begun the diagnostic process to return during their next shift to complete the work. This process could get more complicated depending on shift schedules though. For example if a facility utilizes a rotating schedule, an operator who started a process may only come into work on a four-day schedule. If the operator began a process on the fourth day, waiting three days for the operator to return is not cost effective to the facility. Additionally, if the operator's notes were unclear, the operator may not be available for clarification until the next time the operator returns to work.

With the development of computers, electronic databases are now available for leaving notes electronically to let others know the status of an equipment diagnosis. However, just as computer technology has advanced, so have processing equipment. For example, in semiconductor manufacturing, rigorous test protocols are in place when any piece of equipment fails before being returned to normal operating procedures. In some cases before a piece of equipment is used, a protocol requires an operator to first run a test unit through the equipment to determine whether or not the equipment passes an acceptance criteria. If the equipment does not pass, the operator then has to use a specifically detailed textual description of a corrective procedure that must be followed before using the equipment.

With respect to semiconductors, equipment is typically in a clean room and the procedure is stored electronically and retrieved by the operator using a computer since paper is not allowed in the clean room. Working from a textual readout, or printout on a computer screen, following each of the test(s) that need to be done, and making decisions after each portion of the test as to whether or not the equipment or system has passed or failed can be tedious. Because of the complexity involved, a contracted vendor service may have to be called in to perform the work. However, depending on the vendor service's availability, a specific piece of equipment may be inoperable or out of service for an unacceptable length of time.

### BRIEF DESCRIPTION OF THE INVENTION

The present invention is directed a method and system for diagnosing and tracking a problem associated with a piece of equipment or a machine, system or process. This diagnoses and tracking procedure can occur after a fault has been detected or can be a routine preventative maintenance procedure which could detect a fault before it occurs.

One preferred method comprises implementing a process comprising a plurality of steps represented by a process flow diagram. A table for recording data associated with each of the respective plurality of steps is created. Data in the table responsive to activities associated the plurality of steps as the process implementation progress is recorded. A display is provided where at least a portion of the process flow diagram and/or the table is displayed. An indication is provided on the display associated with a process step of the flow diagram which is associated with a data entry selected from the table. This indication provides a status of the process.

The present invention is also directed to a system that has a memory which stores data representative of a plurality of process flow diagrams, where each flow diagram has a plurality of process steps and are representative of a plurality of tables associated with respective process flow diagrams. The system also has a processor connected to the memory for executing programmed instructions for selecting a process flow diagram and/or an associated table. A data entry device is also provided for entering data into the selected table. The data is responsive to activities resulting from implementing process steps of the selected process flow diagram. A display is provided, connected to the processor, for displaying at least a portion of the selected process flow diagram and/or the associated table.

### BRIEF DESCRIPTION OF THE DRAWINGS

The features and advantages of the present invention will become apparent from the following detailed description of the invention when read with the accompanying drawings in which:

FIG. 1 is an exemplary embodiment of a pass down database table of the present invention;

FIG. 2 is an exemplary embodiment of a flowchart tab and a pass down database table with a flow chart of the present invention;

FIG. 3 is an illustration of a block diagram of exemplary -components that comprise the present invention;

FIG. 4 is an exemplary flow chart of the present invention; and

FIG. 5 is an exemplary flow chart of the present invention.

### DETAILED DESCRIPTION OF THE INVENTION

Before describing in detail various aspects of the present invention, it should be observed that the present invention broadly comprises a novel combination of components and/or processes configured to quickly and reliably meet the need for a passdown and flow chart system that simplifies the process for diagnosing and following protocols where, when multiple individuals must complete diagnosing and follow protocols, information is readily available to allow for a seamless transition between individuals. Accordingly, these components/processes have been represented by generic elements in the drawings, showing only those specific details that are pertinent to the present invention, so as not to obscure the disclosure with structural details or operational interrelationships that will be readily apparent to those skilled in the art having the benefit of the description herein. Additionally, one skilled in the art will recognize that the present invention is applicable to machines, pieces of equipment, systems and/or processes.

The present invention can be embodied in the form of computer-implemented processes and apparatus for practicing those processes. The present invention can also be embodied in the form of computer program code including computer-readable instructions embodied in tangible media, such as floppy disks, CD-ROMS, DVDs, hard drives, or any other computer-readable storage media, wherein when the computer program code is loaded into and executed by a computer(s), the computer(s) becomes an apparatus for practicing the invention. When implemented on a computer(s), the computer program code segments configure the computer(s) to create specific logic circuits or processing modules.

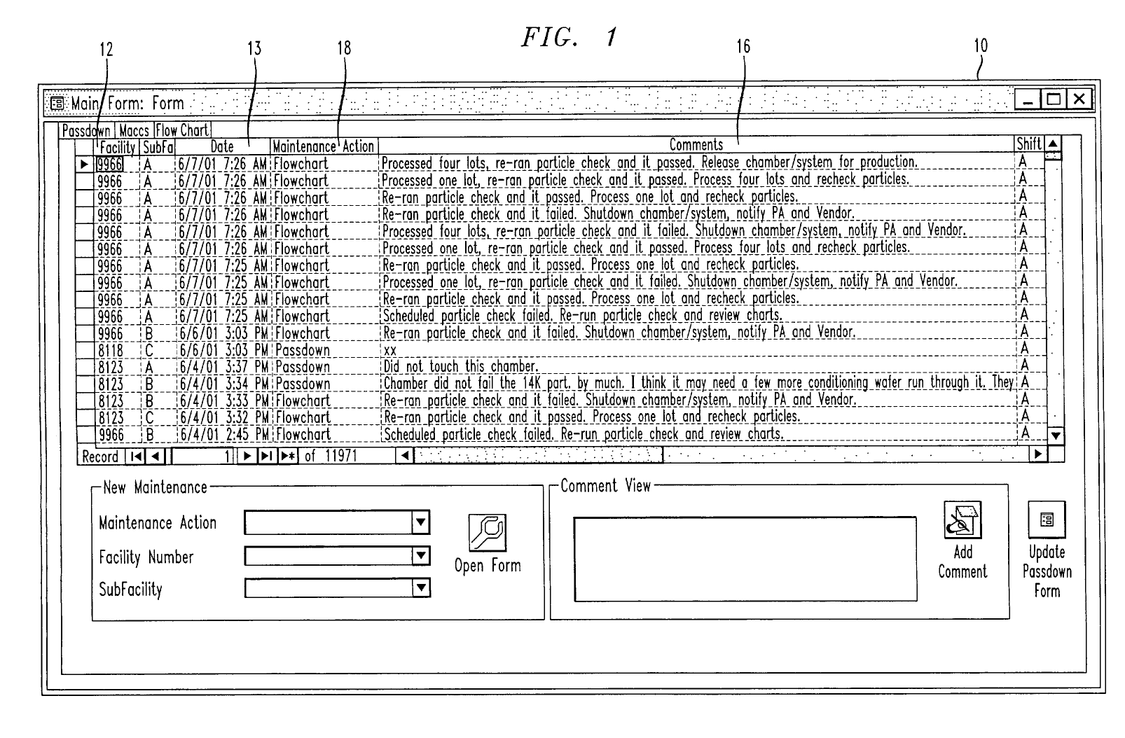

FIG. 1 is an exemplary example of pass down database entry of the present invention as may be viewed on a computer screen. Such a database may be created with any database software program such as Microsoft Access. However, the database can also be maintained in a spreadsheet program such as Microsoft Excel. The database, or database table 10, may be organized and stored in various fields to allow an operator to determine which machine, system, or process has a problem and a date of a particular problem including the identification of the problem associated with the system. As illustrated, a first column 12 identifies a machine that has a problem. A second column 13 identifies a date that the problem occurred. A time of the problem may also be included. A third column 18 identifies a type of problem that did occur along with any comments that a previous operator may have decided to include in the description of the problem. A fourth column 16 identifies if the entry is a pass down or flowchart entry. All of this data is actually stored in a database where the database is integrated with a processor or computer to display the data in a table format. As one skilled in the art will recognize, data can include, but is not limited to, comments, numbers, charts, pictures, multi-medial of any kind, etc.

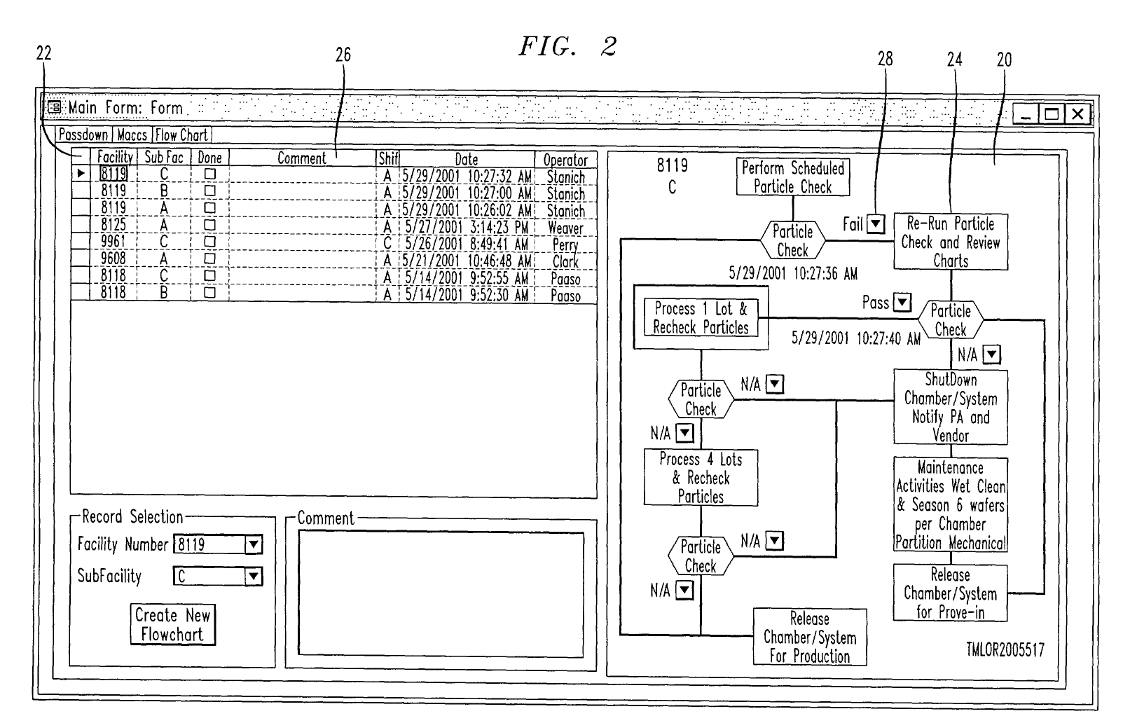

FIG. 2 is an exemplary embodiment of a flowchart tab and a pass down database table of the present invention. The background program, such as Microsoft Access has a plurality of such trouble shooting flowcharts stored in memory with each flow chart associated with a particular type of machine, process, or system. The background program is operated on a computer, or processor, which also maintains the database software program discussed above. In another preferred embodiment, the database software program is operated on a second computer and the resulting database is only displayed on the computer, or processor, operating the background program.

When an operator enters a failure associated with a type of machine, piece of equipment, system or process, the background program automatically retrieves the associated flow chart 20 from memory and then associates that flow chart with the particular machine that is having a problem. In one embodiment, the presentation of the flow chart is with a split screen showing a modified pass down database table 22 specific to a flow chart and the flow chart that corresponds with a protocol for correcting the problem. In another preferred embodiment, not shown, the modified pass down database table is not provided.

At the stage where the operator enters a failure associated with a specific machine and the program automatically provides a flow chart for that specific machine, a correlation between the database entry screen and the flow chart is created. In one preferred embodiment, whenever a node 24 is selected in the flowchart, a form 26 is provided on the database screen to allow the operator to fill in information or select default information about the particular test that is being run. In another preferred embodiment, the background program runs through the flowchart and presents results in a second form, such as a drop down table as is known in the prior art. This information is saved and automatically appears in the database while at the same time the particular area of the flow chart is highlighted 28 so that the operator can quickly look at the flowchart and visually determine exactly where the program is in the diagnostic or testing process.

In a preferred embodiment, a response at a node is either yes/no or pass/fail. One skilled in art will recognize that other forms of notice can be given representing a response. A response can also be highlighted in a certain color, such as red for fail or yellow for pass. Thus, when either the initiating operator or a new operator views flowchart, the operator can quickly determine whether the machine has passed a specific node. Once all conditions are satisfied, the last node is highlighted, the flow chart is closed and the machine is re-qualified to produce product until the next regular process check is due or until the next failure is detected.

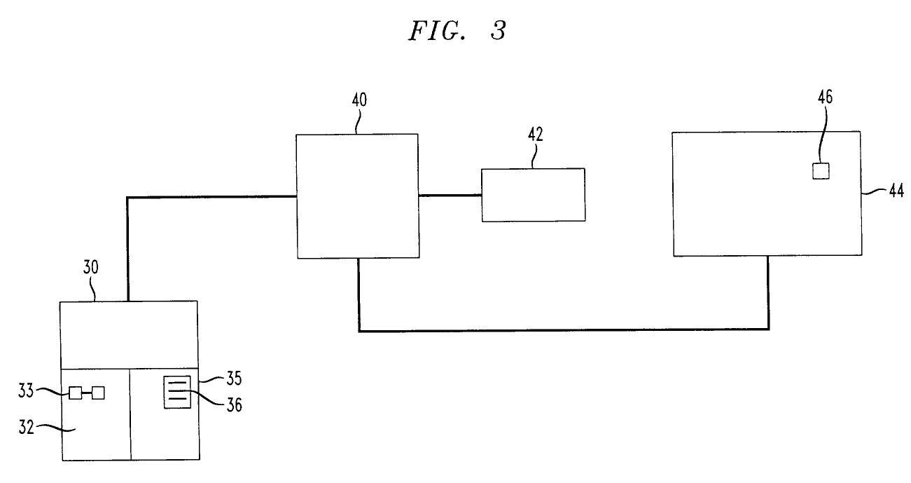

FIG. 3 is an illustration of a block diagram of exemplary components that comprise the present invention. A memory 30 for storing data representative of a plurality of process flow diagrams 32 is provided. Each process flow diagram 32 may comprise a plurality of process steps 33. Each process step 33 is associated with a representative entry 36 in a table 35. Thus a plurality of tables 35 exists, each associated with a process flow diagram 32. In another embodiment, the memory 30 may be a plurality of memory devices where various flow diagrams 32 and tables 35 may reside on different memory devices. A processor 40 is connected to the memory 30 and executes programmed instructions for selecting a process flow diagram 32 and/or an associated table 35. A data entry device 42 is provided for entering data into the selected table 35 responsive to activities implementing the process steps 33 of the selected process flow diagram 32. In a preferred embodiment, the data entry device 42 is provided for a user to enter data. In another preferred embodiment, the data entry device 42 facilitates data entry by selecting an alternative predetermined data entry, or populating the data field with default data. A display 44 is connected to the processor 40 for displaying at least a portion of the selected process flow diagram 32 and/or the associated table 35. The display 44 also has an indicator 46 to notify a user of a status of a process step 33 of the flow diagram 32 associated with a data entry 36 selected from the table 35. In one preferred embodiment an audible indicator is provided.

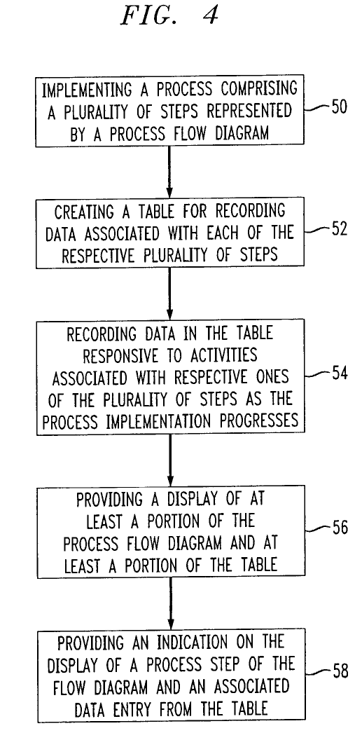

As illustrated in FIG. 4, in operation the present invention will implement a process that has a plurality of steps, which are represented by a process flow diagram, Step 50. A table is created for recording data associated with each of the respective plurality of steps in the process, Step 52. For a given process step, data is recorded in the table that is responsive to activities associated with the process step as the process implementation progresses, Step 54. A display is used to view at least a portion of the process flow diagram and/or at least a portion of the table, Step 56. The amount of the diagram and/or table displayed is dependent upon the size of the display and the complexity of the flow diagram and/or table. An indication is provided on the display to notify a user of the status the process, Step 58. In another preferred embodiment, the indication is an audible indicator, such as a repeated sound or voice recording stating the progress of the process.

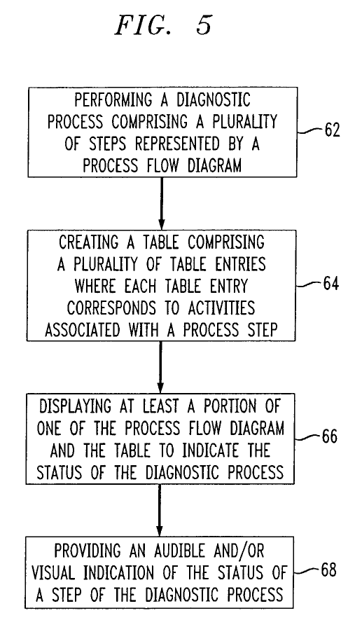

FIG. 5 illustrates another preferred embodiment of the present invention. As illustrated, the present invention performs a diagnostic process, Step 62. A table that has a plurality of table entries where each table entry corresponds to a process step is created, Step 64. At least a portion of the process flow diagram and/or the table is displayed, Step 66. The status of the diagnostic process is indicated to a user, where the method of indicating may be a visual indication and/or an audible indication, Step 68.

While the invention has been described in what is presently considered to be a preferred embodiment, many variations and modifications will become apparent to those skilled in the art. Accordingly, it is intended that the invention not be limited to the specific illustrative embodiment, but be interpreted with the full spirit and scope of the appended claims.

What is claimed is:

1. A method of monitoring a multi-step process, the method comprising:
(a) implementing a process comprising a plurality of steps represented by a process flow diagram;
(b) creating a table for recording data associated with each of the respective plurality of steps;
(c) recording data in the table responsive to activities associated with respective ones of the plurality of steps as the process implementation progresses;
(d) providing a display of at least a portion of the process flow diagram and at least a portion of the table; and
(e) providing an indication on the display of a process step of the flow diagram and an associated data entry from the table.

2. The method of claim 1 further comprising providing data entry into the table by selection of alternative predetermined data entries.

3. The method of claim 1 further comprising providing data entry into the table by populating the table with default data upon its creation.

4. The method of claim 1 further comprising providing data entry into the table by populating the table with data manually entered by a user.

5. The method of claim 1 wherein providing a display further comprises displaying both portions of the process flow diagram and the table simultaneously on the display.

6. The method of claim 1 wherein providing an indication further comprises providing a visual indication of a status of a step of the process flow diagram.

7. The method of claim 1 further comprising providing an audible indication of a status of a step of the process flow diagram.

8. A system for monitoring a multi-step process comprising:
(a) a memory storing data representative of a plurality of process flow diagrams each comprising a plurality of process steps and representative of a plurality of tables, each associated with a respective one of the plurality of process flow diagrams;
(b) a processor connected to the memory executing programmed instructions for selecting one of the process flow diagrams and the associated table;
(c) a data entry device connected to the processor for entering data into the selected table responsive to activities implementing process steps of the selected process flow diagram; and
(d) a display connected to the processor for displaying at least a portion of the selected process flow diagram and associated table.

9. The system of claim 8 wherein the data entry device is a user-operable device.

10. The system of claim 8 wherein the data entry device provides data entry into the selected table by selection of an alternative predetermined data entry.

11. The system of claim 8 wherein the data entry device provides data entry by populating the selected table with default data upon its creation.

12. The system of claim 8 further comprising an indication of completed steps of the process flow diagram on the display.

13. The system of claim 8 wherein the indication is an audible indication of completed steps of the process flow diagram.

14. The system of claim 8 wherein the memory comprises a plurality of memories wherein data representative of a process flow diagram resides in a first memory and a table associated with the process flow diagram resides in a second memory.

15. A method of monitoring a multi-step diagnostic process, the method comprising:
(a) performing a diagnostic process comprising a plurality of steps represented by a process flow diagram;
(b) creating a table comprising a plurality of table entries where each table entry corresponds to activities associated with a process step; and
(c) displaying at least a portion of one of the process flow diagram and the table to indicate the status of the diagnostic process.

16. The method of claim 15 further comprising entering data into the table by at least one of populating the table with a selection of alternative predetermined data entries, populating the table with default data, and entering manual entries by a user.

17. The method of claim 15 further comprising displaying the process flow diagram and the table simultaneously.

18. The method of claim 15 further comprising providing an audible indication of the status of a step of the diagnostic process.
